(19) United States
(12) Patent Application Publication
(10) Pub. No.: US 2014/0320259 A1
(43) Pub. Date: Oct. 30, 2014

(54) BIOMETRIC SECURITY APPARATUS FOR ACCESS AND CONTROL OF A PHYSICAL LOCKING STORAGE UNIT

(71) Applicant: Digitus Biometrics, Inc., Savannah, GA (US)

(72) Inventor: Christopher D. Marsden, Savannah, GA (US)

(21) Appl. No.: 14/357,137

(22) PCT Filed: Nov. 30, 2012
(86) PCT No.: PCT/US2012/067321

§ 371 Date: May 8, 2014

Related U.S. Application Data
(60) Provisional application No. 61/565,165, filed on Nov. 30, 2011.

(51) Int. Cl. G07C 9/00

(52) U.S. Cl. CPC G07C 9/00158
USPC 340/5.52

(57) ABSTRACT

A biometric security apparatus for use with a plurality of server cabinet enclosures is described herein. Each cabinet enclosure is configured with at least one electromechanical lock and a corresponding door. The biometric security apparatus includes a plurality of remote nodes, each remote node configured to provide an output signal to one or more of the at least one electromechanical lock in order to lock or unlock the corresponding door. In one aspect, a bus controller is connected to the plurality of remote nodes and a biometric input device is connected to the controller. In one aspect, a biometric input device is connected to a remote node. The biometric input device is configured to authenticate a user and allow selection of one or more doors to be actuated upon authentication of the user. In one aspect, the bus controller is configured to distribute a command to one or more remote nodes corresponding to doors selected by the user.

### CROSS-REFERENCE TO RELATED APPLICATIONS

This application claims priority to Provisional Application 61/565,165, filed on Nov. 30, 2011, the entire disclosure of which is hereby incorporated by reference in its entirety. In addition, this application contains disclosure that is related to U.S. patent application Ser. No. 13/027,241, filed Feb. 14, 2011, the entirety of which is incorporated herein by reference.

### BACKGROUND

Over the past decades, the significance of security for electronic data has grown in numerous fields, such as, for example, health care, finance, research, education, human resources, and the military. The methods and techniques directed to securing electronic data often focus on preventing digital access to the relevant data (i.e., over the internet).

Although securing digital access to electronic data is important, often overlooked is the importance of securing physical access to sensitive electronic data. In other words, access to the computer hardware system functioning as a server that stores the electronic data must also be secure. Many enclosures for equipment meant to store electronic data are not secured at all or are merely secured using a conventional lock and key solution for each door. Other conventional solutions include systems that require either a magnetic stripe card or a proximity card for unlocking an individual door of an enclosure.

Current techniques for controlling physical access do not provide sufficient security and also fail to balance the requirements of authorized users with security requirements. For example, in facilities with large numbers of servers, conventional solutions require either (1) an unwieldy number of keys or cards that can be cumbersome and difficult or organize or (2) a single key or card to access a large number of enclosures that includes a risk of allowing a single lost/stolen key or card to grant access to a significant amount of electronic data for an unauthorized user.

For developers of security systems, a significant challenge lies in balancing convenience and speed of access for authorized users with accuracy and precision in excluding unauthorized users. Authorized users of physical security systems desire systems which are user-friendly, versatile, customizable, and efficient.

### SUMMARY

The present disclosure relates generally to bus based biometric locking systems and, in one aspect, a fingerprint-controlled locking system adaptable to existing locking solutions such as a server cabinet, and for controlling access thereto. In one aspect, using a single power supply, a system manages access to multiple doors, while only requiring a single network connection and IP address, The system can be an expansible and interactive mechanism including an electrical physical locking unit in conjunction with a computer controlled management system. The system can be managed by central management software.

In one aspect, a solution includes a hardware platform, software platform and firmware that permits biometric solutions to be used in conjunction with conventional locks, such as those used in standard cabinet configurations. This disclosure illustrates a preferred embodiment comprising a server cabinet configuration having at least one accessible door with a biometric validation module responsive to a control signal. The control signal controls an electromechanical locking assembly for locking or unlocking at least one door.

The biometrically access-controlled physical locking unit may be used for both monitoring and providing access for a physical locking unit. The biometrically access-controlled system can provide an array of features including, but not limited to: (1) biometric scanning and input employing multi-step enrollment and encryption processes versus any direct storage of biometric data; (2) hopping code encrypted communication between the host software and a bus controller; (3) operating over a network where user enrollment, access permissioning, and system configuration can be completed from host software; (4) hardware configured to operate independent from host software during a user authentication process; (5) propped door alerts via detection and warning, forced door and tamper alert, and duress entry alert using alternate biometric input; (6) authenticated system management via proprietary software; (7) management software which may be accessed only after biometric authentication thus providing multi-level biometrics; (8) multi-level biometric scanning including multi-layered validation; (9) tracking and recording of all entry events; and (10) biometric authentication process of biometric data prevents hacking via handheld code generators.

Described herein is a biometric security apparatus for use with a plurality of server cabinet enclosures, each cabinet enclosure configured with at least one electromechanical lock and a corresponding door. The biometric security apparatus includes a plurality of remote nodes, each remote node configured to provide an output signal to one or more of the at least one electromechanical lock in order to lock or unlock the corresponding door. In one aspect, a bus controller is connected to the plurality of remote nodes and a biometric input device is connected to the controller. In one aspect, the biometric input device is configured to authenticate a user and allow selection of one or more doors to be actuated upon authentication of the user. In one aspect, the bus controller is configured to distribute a command to one or more remote nodes corresponding to the one or more doors selected by the user.

### BRIEF DESCRIPTION OF THE FIGURES

FIG. 1 is a schematic view of a biometric security apparatus with a single biometric input device;

FIG. 2 shows schematic view of a biometric security apparatus with multiple biometric input devices;

FIG. 3A is a detail view of a first side of a remote node;

FIG. 3B is a detail view of a second side of a remote node;

FIG. 4 is a detail view of a bus controller;

FIG. 5 shows a closed loop operating mode;

FIG. 6 shows an open loop operating mode;

FIG. 7 illustrates an example of a peripheral item;

FIG. 8 shows an example of an integrated biometric locking device;

FIG. 9 is a flowchart for identifying the desired door(s) to actuate; and

FIG. 10 is a flowchart for the user authentication process.

### DETAILED DESCRIPTION OF THE EMBODIMENTS

The exemplary embodiments described herein provide detail for illustrative purposes and are subject to many variations in structure and design. It should be emphasized, however, that the present invention is not limited to a particularly disclosed embodiment shown or described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present disclosure describes both a method and an apparatus for securing, monitoring, alerting, and reporting on events related to access of a plurality of cabinets or enclosures. In one aspect, the system of the instant disclosure can be used by anyone and provides biometric security which authenticates a person and not a token.

In facilities with numerous servers, it is common for each server cabinet enclosure to include a front door and a rear door where each door may be accessed by a user. It is also common that the plurality server cabinet enclosures are arranged in rows.

Described herein is a biometric security apparatus 100 for use with a plurality of server cabinet enclosures 30, each cabinet enclosure 30 configured with at least one electromechanical lock 31 and a corresponding door 32. The biometric security apparatus 100 includes a plurality of remote nodes 40, each remote node 40 configured to provide an output signal to one or more of the at least one electromechanical lock 31 in order to lock or unlock the corresponding door 32. In one aspect, a bus controller 50 is connected to the plurality of remote nodes 40 and a biometric input device 60 is connected to the controller. In one aspect, the biometric input device 60 is configured to authenticate a user and allow selection of one or more doors 32 to be actuated upon authentication of the user. In one aspect, the bus controller 50 is configured to distribute a command to one or more remote nodes 40 corresponding to the one or more doors selected by the user.

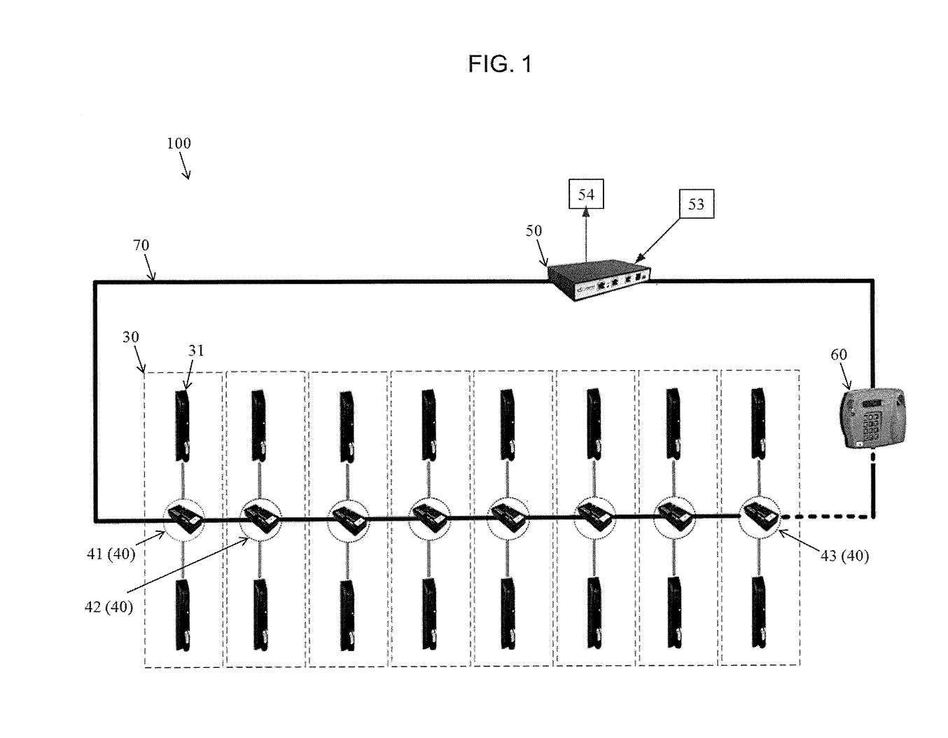

In certain aspects, the biometric input device 60 is a fingerprint or any other type of biometric device (or combination thereof) including but not limited to: facial recognition, iris scanner, retinal scanner, voice recognition, DNA scanner, hand print scanner, typing rhythm, gait, electroencephalogram, or electrocardiogram. The biometric input device may also include a number pad or a QWERTY keyboard. The biometric input device 60 may be located in between one of the (or all of the) remote nodes 40 and the bus controller 50 (as shown in FIG. 1).

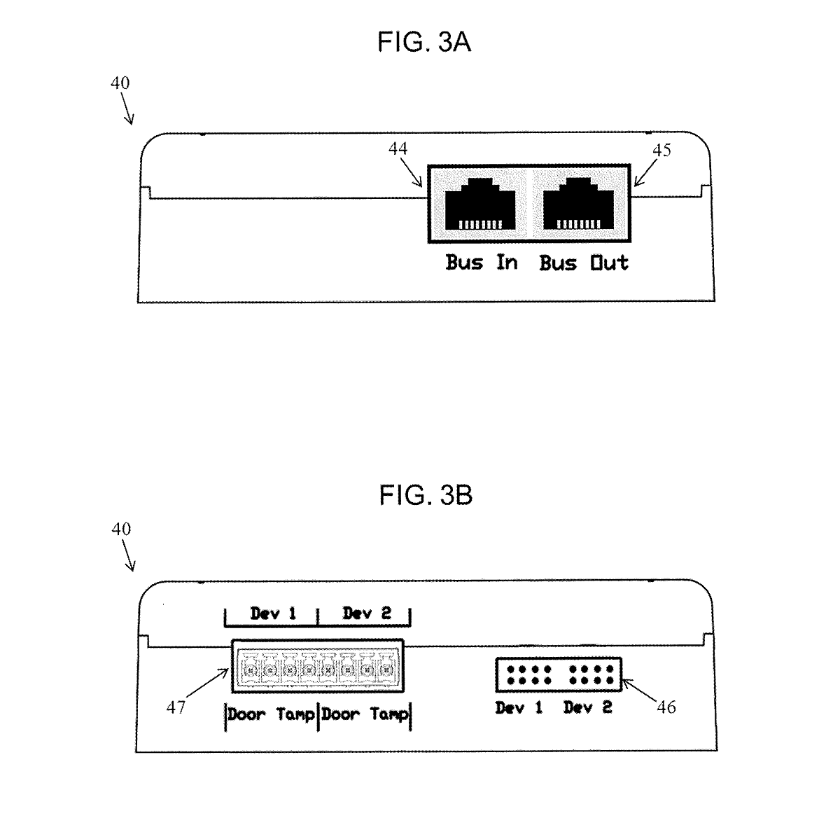

In one aspect, each remote node 40 is mounted inside a server cabinet enclosure 30. The remote node may be as small as 4″×2″×1″ (10.2 cm×5.1 cm×2.6 cm). Furthermore, each remote node is configured such that the remote node does not require rack mount space in the server cabinet enclosure. For example, the remote node may be installed to the underside of a top surface using adhesive. As shown in FIG. 3A, each remote node 40 may include a bus in port 44 and a bus out port 45 (described in greater detail below). As shown in FIG. 3B, each remote node 40 includes at least one lock port 46 for connecting to an electromechanical lock 31. In addition to the bus in port 44, the bus out port 45, and the electromechanical lock ports 46, each remote node 40 may also include a plurality of secondary connection ports 47. The secondary connection ports 47 allow for peripheral items 90 to be connected to the remote node 40. Examples of peripheral items 90 include: door contact sensors (to detect whether a door 32 is open or closed), tamper sensors (to detect whether a side/bottom/top static enclosure wall is breached or modified), temperature sensors, humidity sensors, motion sensors, magnetic sensors, noise sensors (i.e., microphones), light sensors, weight sensors, electromagnetic field sensors, still cameras, and video cameras.

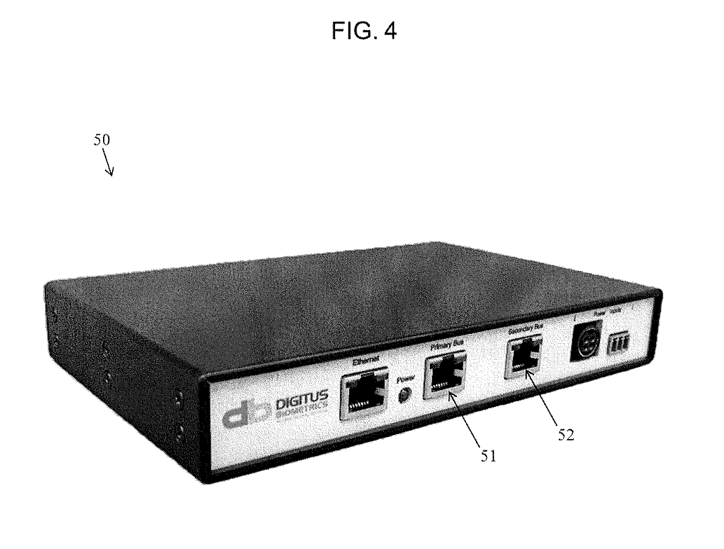

As illustrated in FIG. 4, the bus controller 50, in certain aspects, includes a primary bus connection 51 and a secondary bus connection 52 (described in greater detail below). In addition, the bus controller may also be connected to a power supply 53 and connected to a network 54 (see FIG. 4). In one aspect, the bus controller is configured to connect to 32 remote nodes and each remote node is configured to connect to 8 doors.

In certain aspects, the biometric input device 60, the plurality of remote nodes 40, and the bus controller 50 are connected via wired connections in a loop bus 70. Furthermore, the bus controller may distribute a data signal and an electrical power signal to the plurality of remote nodes 40 through the loop bus 70 via a single wired input port and a single wired output port at each of the remote nodes 40. Allowing data and electrical power to be distributed to the remote nodes via single wired connection minimizes space and wiring requirements for the security apparatus. Typically, the quantity and associated space requirements of wiring in addition to electrical power constraints are significant in facilities with large numbers of servers.

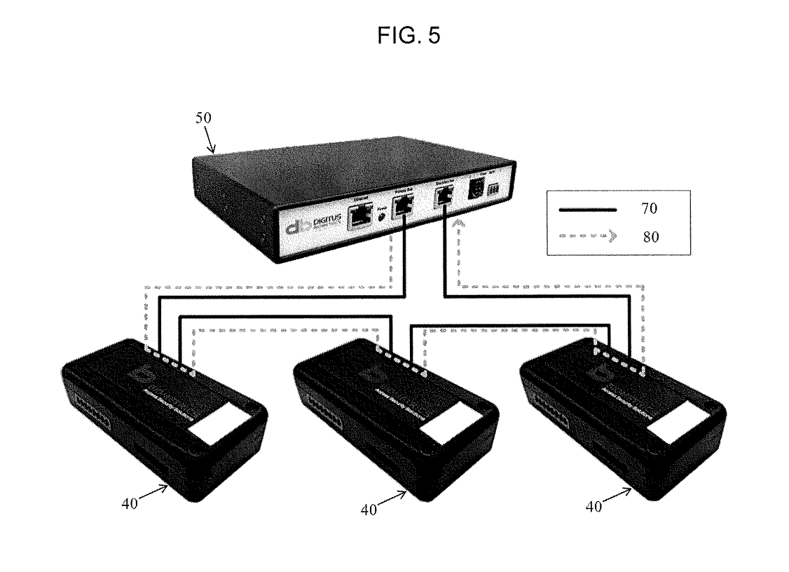

The apparatus described herein may be configured such that the loop bus 70 operates as a closed loop circuit that begins and ends at the bus controller 50 as shown in FIG. 5. FIG. 5 also illustrates signal 80 such that the direction of the arrow indicates the direction of travel for the electrical signal and/or data signal. In one aspect, the electrical wire used to connect the biometric input device 60, the plurality of remote nodes 40, and the bus controller 50 is Ethernet cable such as Category 5 cable, Category 5e cable, Category 6 cable, or Category 6a cable (i.e., Augmented Category 6).

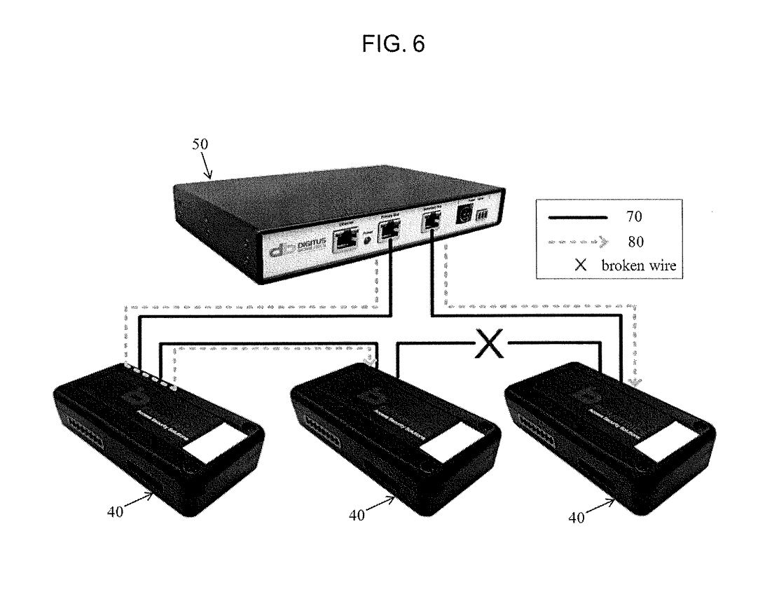

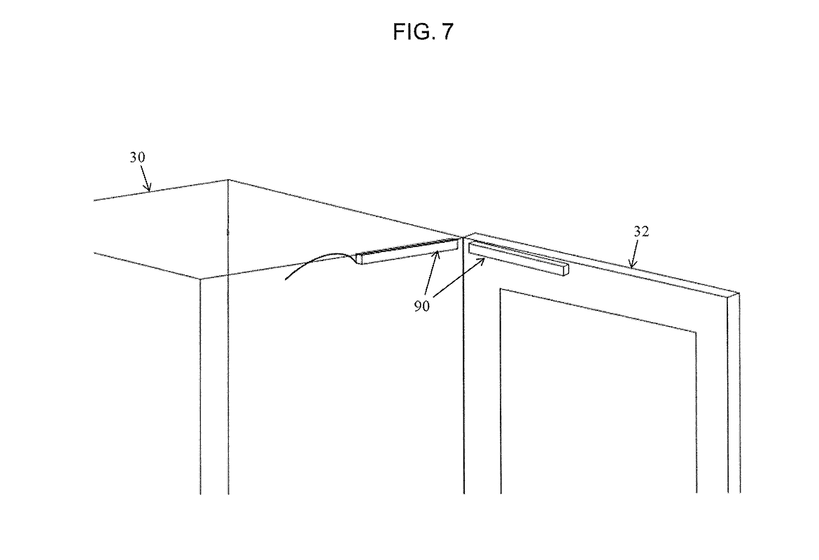

In certain aspects, if a wire or connection in the closed loop circuit breaks, the loop bus is configured to operate as one or more open loop circuits that each begin at the bus controller 50. Thus, the apparatus may adapt to changes in hardware configuration in real time. An example of an open loop operating mode is illustrated in FIG. 6. Like FIG. 5, FIG. 6 illustrates signal 80 such that the direction of the arrow indicates the direction of travel for the electrical signal and/or data signal.

In one aspect, the bus controller 50 includes a primary bus connection 51 and a secondary bus connection 52, and each remote node 40, as described above, includes a bus in port 44 and a bus out port 45. In the closed loop configuration described above, the primary bus connection 51 of the bus controller 50 may output a signal 80 (i.e., both a data signal and an electrical power signal) that is sent, in series, to all of the remote nodes 40. In one aspect, the remote node closest to the bus controller 50 (i.e., having a direct wired connection between the primary bus connection 51 of the bus controller 50 and the bus in port 44 of the remote node) is known as the first remote node 41 and would receive the signal 80 through the bus in port 44. In certain aspects, each remote node 40 may have an individual unique assigned identification number such that the data distributed from the bus controller 50 includes individually identifiable instruction sets for each remote node 40. The first remote node 41 may receive any required electrical power through the bus in port 44 in addition to instructions or commands relevant to the first remote node 41. For example, the first remote node 41 may receive instructions distributed from the bus controller 50 to lock or unlock an electromechanical lock 31 associated with the first remote node 41. The first remote node 41 sends an output signal through the bus out port 45 (i.e., both a data signal and an electrical power signal). In certain aspects, this output signal includes: (1) electrical power signals, including those for the other remote nodes 40 (i.e., other than the first remote node) distributed from the bus controller 50 that are associated with individual unique assigned identification numbers of remote nodes other than the first remote node; (2) instruction or command data signals relevant to the other remote nodes (i.e., other than the first remote node) distributed from the bus controller 50 that are associated with individual unique assigned identification numbers of remote nodes other than the first remote node; (3) feedback instruction or command data signals relevant to the first remote node 41 sent back to the bus controller 50 or to the biometric input device 60, the feedback instructions or commands may include confirmation that a requested operation is complete (i.e., unlocking or locking an electromechanical lock 31 associated with the first remote node 41) or a warning or alarm signal based on input from a peripheral item 90 as described above; and (4) any communication between the bus controller 50 and the biometric input device 60 (i.e., if the biometric input device 60 is located upstream of the first remote node 41). In one aspect, the next remote node closest to the first remote node 41 (i.e., having a direct wired connection between the bus out port 45 of the first remote node 41 and its bus in port 44) is known as the second remote node 42 and would receive an input signal through its bus in port 44. The second remote node 42 receives power and data signals through its bus in port 44 originally sent from the bus controller 50 including a specific signal based on its unique assigned identification number (i.e., a different signal than the one intended for the first remote node 41). Similar to the first remote node 41, the second remote node 42 sends an output signal through its bus out port 45. The output signal of the second remote node 42 is received by a subsequent remote node similar to the output signal from the first remote node 41 sent to the second remote node 42 (and repeated for N-nodes) or, if the second remote node is the N-node 43 (i.e., the last node) the output signal, including the feedback instruction or command signals for all nodes, is sent to the secondary bus connection 52 of the bus controller 50.

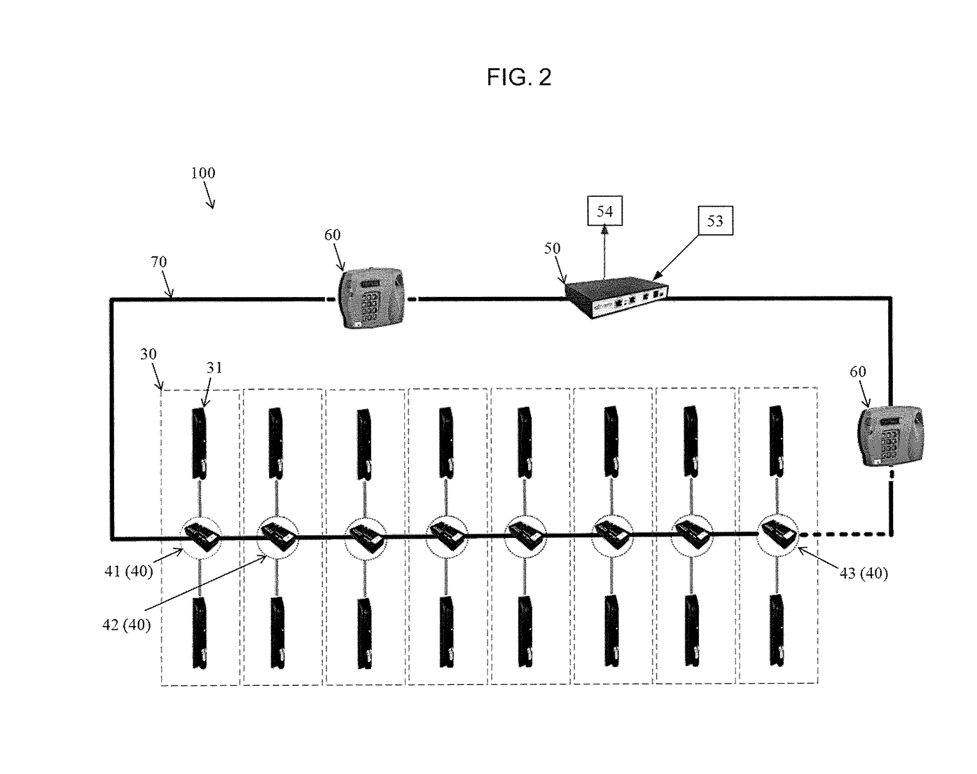

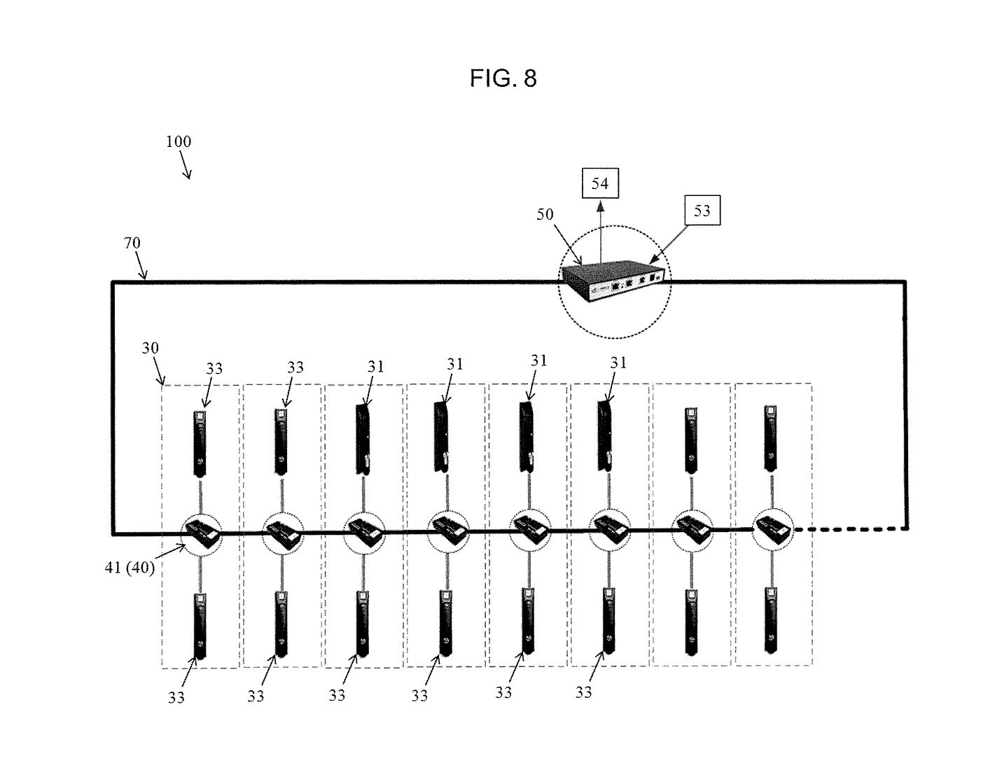

In certain aspects, a plurality of biometric input devices 60 are connected to the controller. FIG. 1 shows a single biometric input device 60 connected to the bus controller 50, but there may be more than one connected to the bus controller (i.e., as shown in FIG. 2). In another aspect, at least one of the biometric input devices is integrated with one of the electromechanical locks to form an integrated biometric locking device 33 as illustrated in FIG. 8. In other words, a biometric input device may be directly connected to a remote node enabling user authentication. The integrated biometric locking device 33 connects to a remote node 40 in a similar manner to the electromechanical lock 31. Furthermore, in certain aspects, the biometric portion of the integrated biometric locking device 33 allows a user to access or activate the integrated locking mechanism and one or more additional electromechanical lock 31.

In one aspect, the integrated biometric locking device 33 allows an authentication process to occur at the individual cabinet level such that a biometric locking device is present on each door 32. In addition, it is also possible to have a biometric input device 60 on the front door of a cabinet, such that the biometric input device 60 may be used to lock or unlock multiple doors 32 of a cabinet.

In one aspect, the bus controller and the biometric input device are separate units. For example, see FIG. 1.

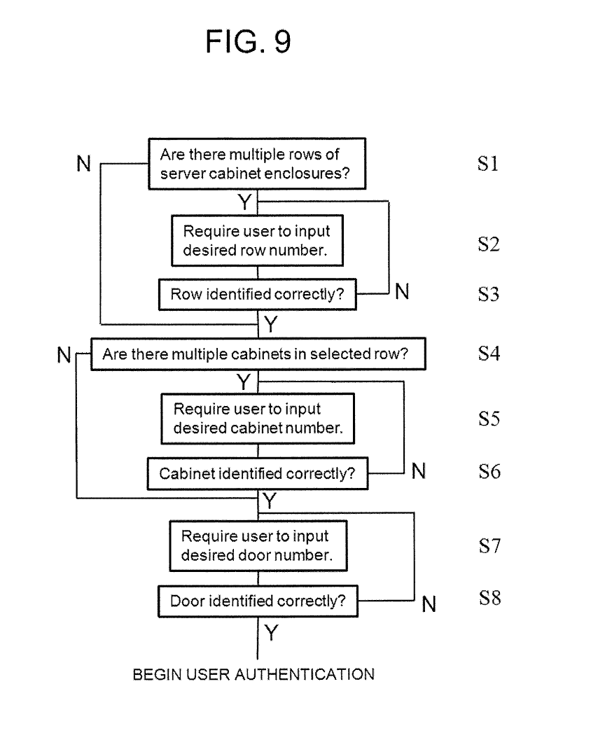

In certain aspects, the user must identify the door or doors that are to be locked or unlocked. As shown in FIG. 9, the user must identify the row or rows to be accessed in step S2 (if multiple rows exist). Similarly, the user must identify the cabinet or cabinets to be accessed in step S5 (if multiple cabinets exist). In addition, the user must identify the door or doors to be accessed in step S7. Furthermore, in one aspect, the user is required to input a key during steps S2, S5, and S7 before proceeding to the subsequent step.

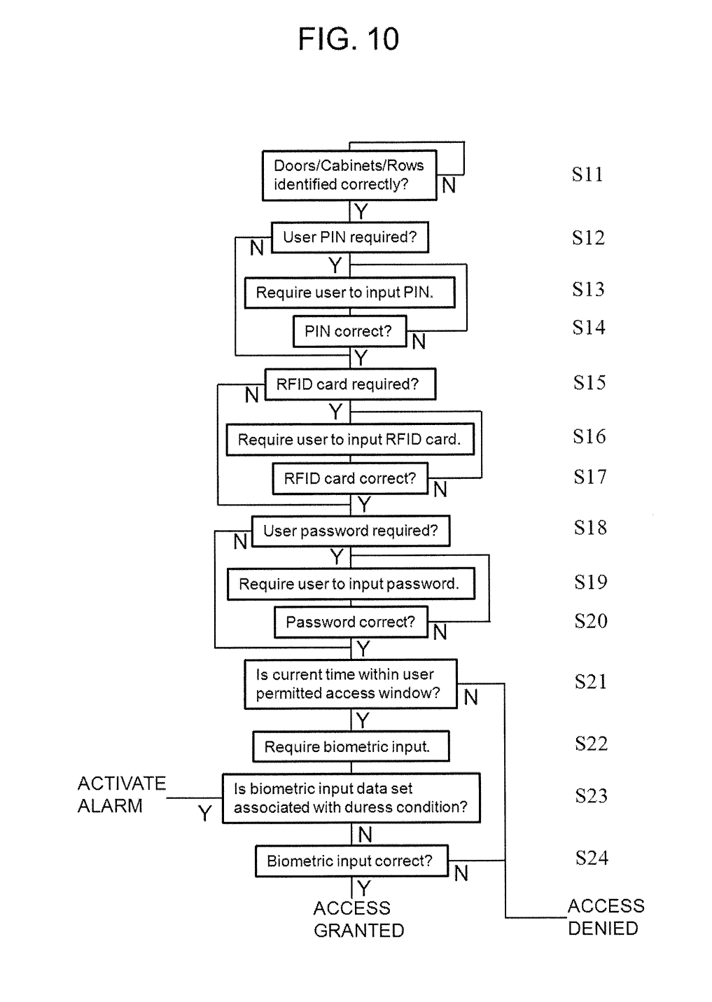

In one aspect, the user authentication process is shown in FIG. 10. The user may be required to enter a PIN number, enter a password, or scan a RFID (radio-frequency identification) card before proceeding. If the user enters an incorrect PIN/password or scans an improper RFID card, the user is prompted to enter the information again (see steps S13-S14, steps S16-S17, and steps S19-S20). In one aspect, there may be a predetermined limit on the number of times the user may input incorrect information before the user is denied access. Step S21 provides a time window when a user is allowed to access individual doors 32 (i.e., different time windows may be created for different doors). Thus, if a user attempts to access a door outside of the allowed time window, access will be denied. The user inputs biometric data after the prompt in step S22. As described above in relation to the biometric input device 60, the biometric input data set may be numerous types of biometric data or any combination thereof (i.e., the system may require multiple sub-steps during step S22). In one embodiment, there is an alternative biometric data set for a user such that entry of the alternative biometric data set indicates a duress condition (i.e., if the user if forced to enter data). The alternative biometric data set may be, for example, scanning a different finger or a different hand than normal, or the alternative biometric data set may be a different sequence than the user's typical required input, such as retinal scan occurring before fingerprint.

The previously described embodiments are merely examples. For example, the biometric security apparatus may include wireless connections to form a wireless mesh network where the remote nodes 40 are connected to one another through a cloud-based mesh network (a mesh cloud). Any changes to the remote nodes 40 and associated hardware of the mesh network elicit automatic reconfiguration of the mesh network based on available hardware.

The foregoing descriptions of specific embodiments have been presented for purposes of illustration and description. They are not intended to be exhaustive or to limit the invention to the precise forms disclosed, and obviously many modifications and variations are possible in light of the above teaching. The embodiments were chosen and described in order to best explain principles and practical applications of the invention, and to thereby enable others skilled in the art to best utilize the invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

1. A biometric security apparatus for use with a plurality of server cabinet enclosures, each cabinet enclosure configured with at least one electromechanical lock and a corresponding door, the biometric security apparatus comprising:
a plurality of remote nodes, each remote node configured to provide an output signal to one or more of the at least one electromechanical lock in order to lock or unlock the corresponding door;
a bus controller connected to the plurality of remote nodes; and
a biometric input device connected to the controller, the biometric input device configured to authenticate a user and allow selection of one or more doors to be actuated upon authentication of the user,
wherein the bus controller is configured to distribute a command to one or more remote nodes corresponding to the one or more doors selected by the user.

2. The biometric security apparatus according to claim 1,
wherein the biometric input device, the plurality of remote nodes, and the bus controller are connected via wired connections in a loop bus,
wherein the bus controller distributes a data signal and an electrical power signal to the plurality of remote nodes through the loop bus via a single wired input port and a single wired output port at each of the remote nodes, and
wherein the loop bus is configured to operate as a closed loop circuit that begins and ends at the bus controller.

3. (canceled)

4. The biometric security apparatus according to claim 2
wherein, if a wire or connection in the closed loop circuit breaks, the loop bus is configured to operate as one or more open loop circuits that each begin at the bus controller.

5. The biometric security apparatus according to claim 4,
wherein the bus controller includes a primary bus connection and a secondary bus connection, and
wherein each remote node includes a bus in port and a bus out port.

6. The biometric security apparatus according to claim 1,
wherein the biometric input device, the plurality of remote nodes, and the bus controller are connected via wireless connections.

7. The biometric security apparatus according to claim 6,
wherein the biometric input device, the plurality of remote nodes, and the bus controller are connected in a wireless mesh network.

8. The biometric security apparatus according to claim 1 further comprising:
a plurality of biometric input devices connected to the controller.

9. The biometric security apparatus according to claim 8,
wherein at least one of the biometric input devices is integrated with one of the electromechanical locks.

10. The biometric security apparatus according to claim 1,
wherein the bus controller and the biometric input device are separate units.

11.-13. (canceled)

14. The biometric security apparatus according to claim 1,
wherein each remote node receives an input signal from a peripheral item.

15. A method for operating a biometric security apparatus for use with a plurality of server cabinet enclosures, each cabinet enclosure configured with an electromechanical lock and a door, the method comprising:
installing a plurality of remote nodes, each remote node configured to provide an output signal to one or more of the electromechanical locks in order to lock or unlock one or more of the corresponding doors;
connecting a bus controller to the plurality of remote nodes; and
authenticating a user and allowing selection of one or more doors to be actuated upon authentication of the user, the authentication occurring via (a) one or more biometric input devices connected to the controller and (b) an additional non-biometric input,
wherein the bus controller is configured to distribute a command to one or more remote nodes corresponding to the one or more doors selected by the user.

16. (canceled)

17. The method according to claim 15, wherein the non-biometric input is a RFID card.

18. The method according to claim 15, wherein the non-biometric input is a user-specific PIN number.

19. The method according to claim 15,
wherein the biometric input device, the plurality of remote nodes, and the bus controller are connected via wired connections in a loop bus, and
wherein the bus controller distributes a data signal and an electrical power signal to the plurality of remote nodes through the loop bus via a single wired input port and a single wired output port at each of the remote nodes.

20. The method according to claim 19,
wherein the loop bus is configured to operate as a closed loop circuit that begins and ends at the bus controller.

21. The method according to claim 20,
wherein, if a wire or connection in the closed loop circuit breaks, the loop bus is configured to operate as one or more open loop circuits that each begin at the bus controller.

22. The method according to claim 21,
wherein the bus controller includes a primary bus connection and a secondary bus connection, and
wherein each remote node includes a bus in port and a bus out port.

23. (canceled)

24. The method according to claim 15,
wherein at least one of the biometric input devices is integrated with one of the electromechanical locks.

25.-28. (canceled)

29. The method according to claim 15,
wherein during the authentication step, a user under duress who inputs an alternative biometric data set into biometric input device will activate an alarm condition.

30. The method according to claim 15,
wherein if a user inputs a proper biometric data set during the authentication step, if the biometric data set input occurs outside of a predetermined time window, the user is denied access.
